(19) United States
(12) Patent Application Publication
(10) Pub. No.: US 2001/0033457 A1
(43) Pub. Date: Oct. 25, 2001

(54) Magnetic recording disk, and method and system for manufacturing a magnetic recording disk

(76) Inventors: Shinji Furukawa, Tokyo (JP); Miho Sakai, Tokyo (JP); Naoki Watanabe, Tokyo (JP)

Correspondence Address: KANESAKA AND TAKEUCHI, 1423 Powhatan Street, Alexandria, VA, 22314, US

(21) Appl. No.: 09/827,322

(22) Filed: Apr. 6, 2001

(30) Foreign Application Priority Data
Apr. 12, 2000 (JP) 2000-111089
May 10, 2000 (JP) 2000-136879

(51) Int. Cl. G11B 5/82

(52) U.S. Cl. 360/135; 428/694 SG

(57) ABSTRACT

This invention presents a magnetic recording disk comprising a disk-shaped substrate and a magnetic film provided on the substrate for magnetic recording. The substrate is made of glass. A texture for giving magnetic anisotropy with the magnetic film is formed on a surface of the substrate. A substrate coat is deposited over the texture. The magnetic film is provided on the substrate coat. This invention also presents a method and a system for manufacturing the magnetic recording disk. The method comprises a step to form the texture with a surface of the substrate, a step to deposit the substrate coat over the texture, and a step to deposit the magnetic film on the substrate coat. The system comprises a texture formation apparatus that forms the texture with a surface of the substrate, a substrate-coat deposition apparatus that deposits the substrate coat over the texture, and a main film-deposition apparatus that deposits films including the magnetic film on the substrate coat.

### BACKGROUND OF THE INVENTION

The invention of this application relates to a magnetic recording disk such as a hard disk for external storage of a computer. Magnetic recording disks such as hard disks and flexible disks are widely used for external storage of computers. The magnetic recording disks is basically so configured that a magnetic film is provided on a disk-shaped substrate.

One of the most important factors in evaluating such the magnetic recording disks is recording reliability. The recording reliability means that recorded information must be sustained semi-permanently. One problem with respect to the recording reliability is thermal decay. When a magnetic domain is magnetized, theoretically it sustains the magnetization unless the inverse magnetic field is applied to it.

Practically, however, it dissolves the magnetization slightly and slightly from the thermal decay as time passes. Therefore, permanent sustenance of the magnetization is impossibly unless the magnetic domain is cooled at the absolute zero temperature. If the problem of the thermal decay appears extremely, recorded information may vanish partially after several years has passed. Such the result is much serious in case that the magnetic recording disk is used for semi-permanent information preservation.

Recently it has been turned out that to give magnetic anisotropy with a magnetic film is effective for suppressing the thermal decay. The magnetic anisotropy is the phenomenon that intensity of magnetization differs depending on direction of magnetic field for magnetization. Otherwise, it can be expressed that coercive force differs depending on direction of magnetization.

Currently, as a means for giving the magnetic anisotropy, it is considered to orient array of crystals composing a magnetic film. Magnetic films are often deposited by the sputtering. Films deposited by the sputtering are usually amorphous. However, when the sputtering is carried out under a high temperature, a partially or locally crystallized film can be deposited because the film is deposited as atoms composing the film migrate. In this mechanism of the deposition, when length of a crystal axis of the magnetic film almost corresponds to length of a crystal axis of an underlying film, the magnetic film tends to be deposited on the underlying film in state that the crystal axis direction of the magnetic film corresponds to that of the underlying film. Therefore, if each crystal axis of the underlying film is oriented to a fixed direction, each crystal axis of the magnetic film is oriented to the same direction as well. When a magnetic film is composed of crystals oriented to a fixed direction, coercive force of a magnetic domain magnetized along the direction tends to be greater than another magnetic domain magnetized along another direction. That is, the magnetic anisotropy is established.

As another method for giving the magnetic anisotropy with a magnetic film, there is the method to form minute grooves mechanically on an underlying film prior to deposition of a magnetic film. When a film is deposited on a surface having minute grooves, each crystal axis of the film tends to be oriented to directions of grooves, resulting in that the magnetic anisotropy along the directions of the grooves is given with the magnetic film. In this specification, such configuration for giving the magnetic anisotropy is called “texture”.

The above point is described taking a hard disk into an example. Conventionally, a substrate made of aluminum is employed in manufacturing a hard disk. A NiP (nickel phosphide) film is deposited on the aluminum-made substrate. Minute grooves are formed on the NiP film, composing the texture. Because hard-disk drives carry out write and read-out of data as rotating a disk around the center axis of the disk, each magnetic domain is magnetized along a circumferential direction, more exactly a direction corresponding to a tangent on a circle coaxial with the disk. Therefore, the magnetic anisotropy is preferably to a circumferential direction. Considering this point, the texture is circumferential minute grooves coaxial with the substrate. The minute grooves form a saw-tooth-wave in cross section.

The minute grooves are formed utilizing a board on which many highly hard grains such as diamond grains are fixed The substrate is rotated as the board is in contact on the substrate. As a result, the substrate is rubbed with the board, thereby forming the grooves. After forming the grooves, an underlying film is deposited on the NiP film. Then, a magnetic film is deposited on the underlying film. Because each crystal of the underlying film is oriented to a circumferential direction, each crystal of the magnetic film is oriented to a circumferential direction as well As a result, the magnetic anisotropy where coercive force is greater in circumferential directions is established with this magnetic film.

However, the above method has problems as described next.

First, the method to grind a film made of metal such as NiP has the difficulty in forming a texture uniformly and accurately in size. If a texture is made out of uniform, a magnetic head easily collides with a peak formed of neighboring two grooves in writing and reading out data. This affects the reliability and the stability of write and read-out of data.

Second, a so-called burr is easily formed in the method to grind a film made of metal. When an underlying film or a magnetic film is deposited over the burr, the film may grow abnormally at the burr. This may lead to deformation defect of the underlying film or the magnetic film.

### SUMMARY OF THE INVENTION

Object of this invention is to solve problems described above. To accomplish this object, the invention presents a magnetic recording disk, comprising a disk-shaped substrate and a magnetic film provided on the substrate for magnetic recording. The substrate is made of glass. A texture for providing magnetic anisotropy with the magnetic film is formed with a surface of the substrate. A substrate coat is deposited over the texture. The magnetic film is provided on or above the substrate coat.

This invention also presents a method for manufacturing the magnetic recording disk. This method comprises a step to form the texture with the surface of the substrate, a step to deposit the substrate coat over the texture, and a step to deposit the magnetic film on the substrate coat

This invention also presents a system for manufacturing the magnetic recording disk. This system comprises a texture formation apparatus that forms the texture with the surface of the substrate, a substrate-coat deposition apparatus that deposits the substrate coat over the texture, and a main film-deposition apparatus that deposits films including the magnetic film on the substrate coat.

### BRIEF DESCRIPTION OF DRAWINGS

FIG. 1 is a schematic cross-sectional view of a magnetic recording disk of an embodiment of the invention.

FIG. 2 is a schematic cross-sectional view of the texture 17 formed on the substrate 11.

FIG. 3 is a schematic perspective view of the texture 17 formed on the substrate 11.

FIG. 4 is a schematic view of a magnetic recording disk manufacturing system of an embodiment of the invention.

FIG. 5 is a schematic view of the texture formation apparatus 2 shown in FIG. 4.

FIG. 6 is a schematic plane view of the substrate-coat deposition apparatus 4 shown in FIG. 4.

### DETAILED DESCRIPTION OF PREFERRED EMBODIMENTS

Preferred embodiments of the invention are described as follows.

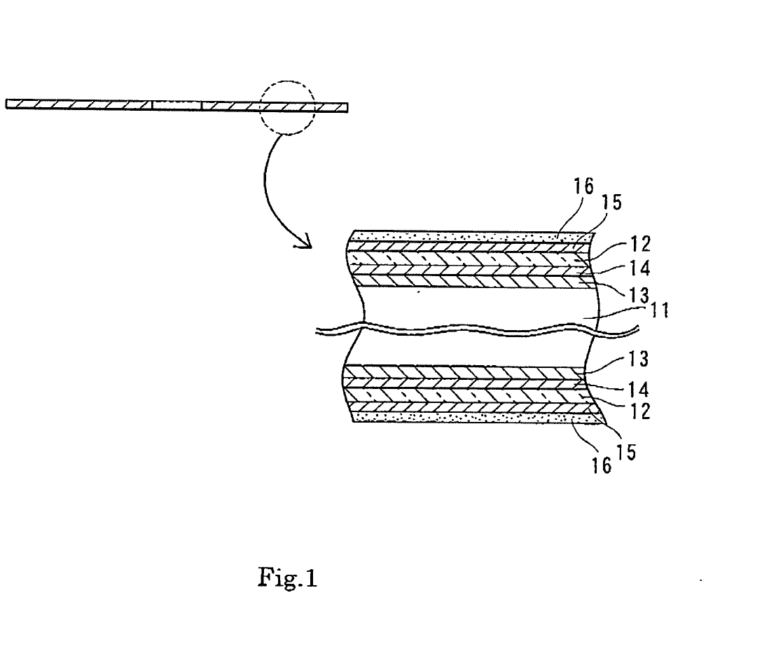

FIG. 1 is a schematic cross-sectional view of a magnetic recording disk of an embodiment of the invention. The magnetic recording disk shown in FIG. 1 is composed of a disk-shaped substrate 11, a magnetic film 12 deposited on the substrate 11 for magnetic recording, and other components. Concretely, the magnetic recording disk has the multi-layered structure where a substrate coat 13, an underlying film 14, the magnetic film 12, an overcoat 15, and a lubricant film 16 are deposited on the substrate 11 in this order. The substrate coat 13 is deposited mainly for obtaining sufficient adhesion intensity of the underlying film 14 and the magnetic film 12 onto the substrate 11. The underlying film 14 is provided on purpose to enhance magnetic characteristics of the magnetic film 12, and to improve adhesion intensity of the magnetic film 12 onto the substrate coat 13. The overcoat 15 is provided to protect the magnetic film 12. The lubricant layer 16 is provided considering collision of a magnetic head in writing and reading out data. As shown in FIG. 1, the substrate coat 13, the underlying film 14, the magnetic film 12, the overcoat 15, and the lubricant film 16 are provided on both surfaces of the substrate 11. This is because information storage is carried out at the both sides of the substrate 11.

One point characterizing this embodiment is that the substrate 11 is made of glass. For example, N5 manufactured by HOYA Corporation can be used as the substrate 11. Generally, the Young's modulus of glass is higher than aluminum, suffering less transformation. Recent magnetic recording disks are rotated at a higher speed for reducing time to write and read out data. The glass-made substrate 11 is superior in less transformation even under high-speed rotation.

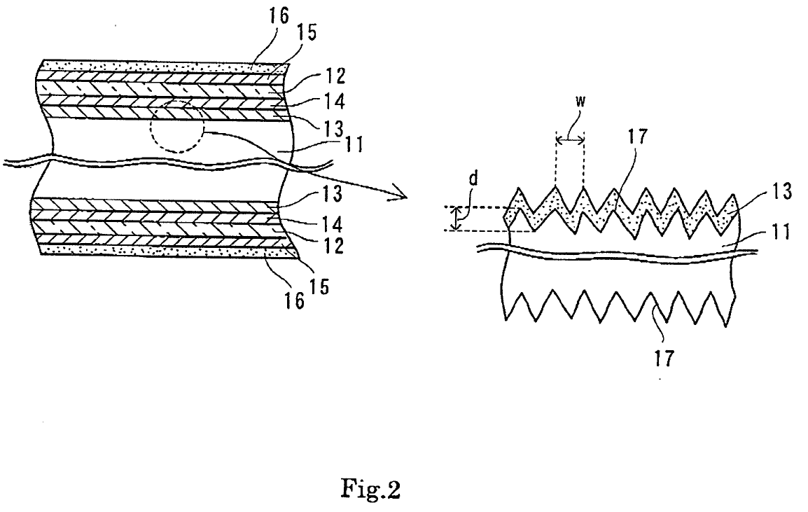

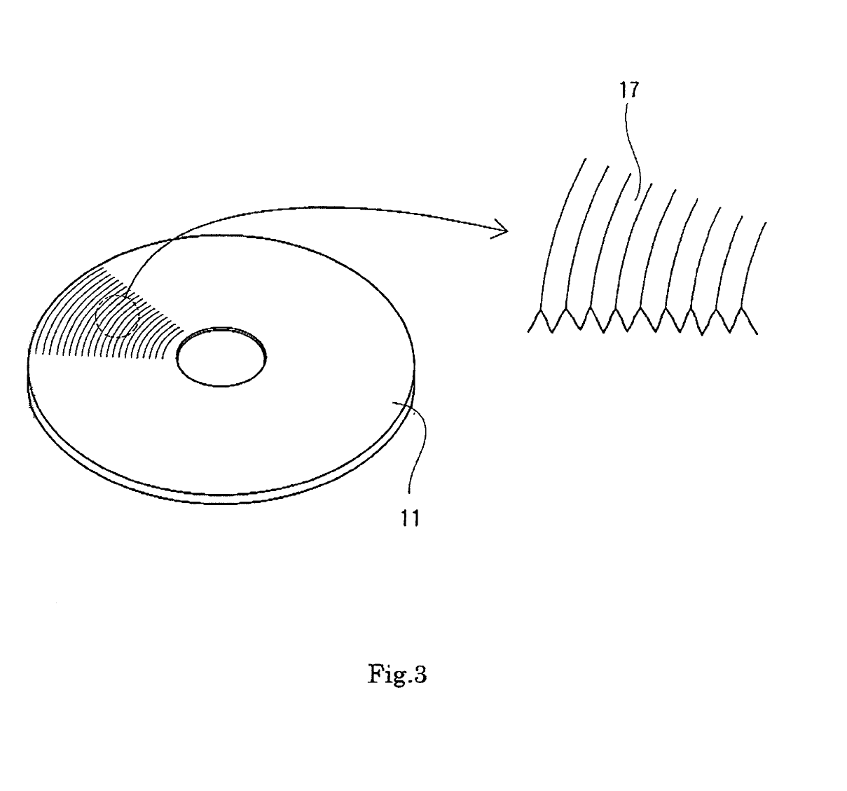

Another point characterizing this embodiment is that a texture is formed directly on the substrate 11. This point is described using FIG. 2 and FIG. 3. FIG. 2 is a schematic cross-sectional view of the texture 17 formed on the substrate 11. FIG. 3 is a schematic perspective view of the texture 17 formed on the substrate 11

As shown in FIG. 2, the texture 17 is saw-tooth-wave-shaped in cross section. As understood from FIG. 3, the texture is composed of many grooves elongated along circumferences coaxial with the substrate 11. Showing an example of size of the texture 17, depth d of each groove is about 4-50 angstrom, and width w of each groove is about 250-350 angstrom. As shown in FIG. 2, the texture 17 is formed with the both surfaces of the substrate 11.

Glass, which the substrate 11 is made of, is preferably amorphous. Of course, crystallized glasses are commercially available. However, when a texture is formed by grinding a crystallized-glass-made substrate, the texture probably may be made out of uniform as well as by grinding a film made of metal.

A further point characterizing this embodiment is that the substrate coat 13 is deposited by the sputtering. As described, this embodiment is characterized by that the texture 17 is formed directly on the glass-made substrate 11. In this case, it is not impossible to prepare the substrate coat 13 on the substrate 11 by a plating method. However, the plating method has the difficulty in preparing the substrate coat 13 preserving the configuration of the texture 17 In the plating method, it is almost impossible to prepare the substrate coat 13 tracing the surface of the minute grooves. The top surface of the prepared substrate-coat 13 would be almost flat.

Considering this point, the substrate coat 13 is deposited by the sputtering in this embodiment. Because a film for the substrate coat 13 is deposited tracing the concavo-convex surface of the substrate 11, the substrate coat 13 is deposited preserving the configuration of the texture 17.

Instead of the NiP film, NiB (nickel boride) film is employed as the substrate coat 13. Thickness of the substrate coat 13 is about 10-70 nm. The surface configuration of the substrate coat 13 is the same as the texture 17 formed on the substrate 11.

A CrMo film, for example, is deposited as the underlying film 14 by the sputtering as well. Thickness of the underlying film 14 is about 5-15 nm. A CoCrTaPt film, for example, is deposited as the magnetic film 12 by the sputtering as well. Thickness of the magnetic film 12 is about 15-20 nm A highly hard carbon film is deposited as the overcoat 15 by the sputtering or the chemical vapor deposition (CVD). Thickness of the overcoat 15 is about 30-50 nm. Fluoride lubricant such as perfluoropolyether (PEPE) is used for the lubricant film 16. The lubricant film 16 is prepared by a dipping method, a spin-coating method, or a spraying method. Thickness of the lubricant film 16 is about 1-2 nm.

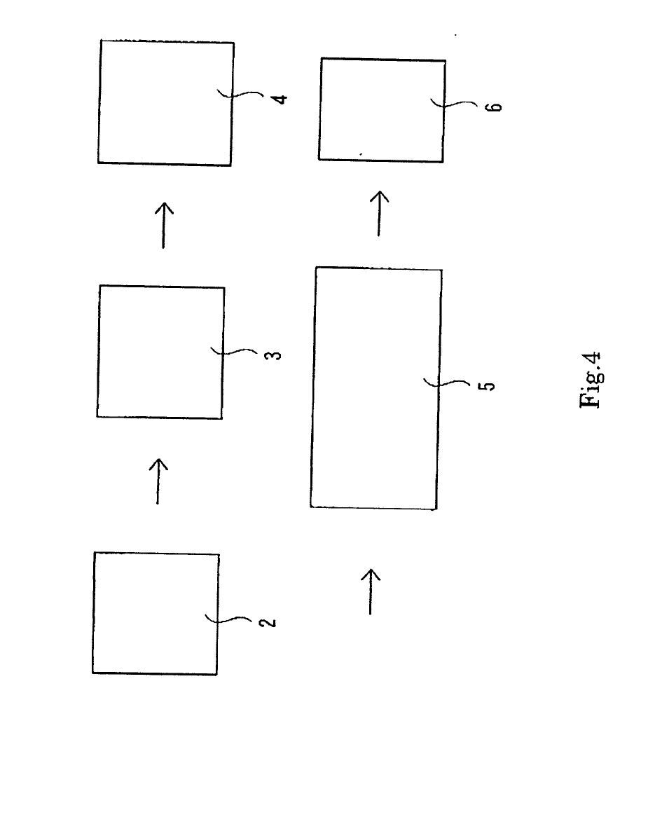

Next, a magnetic recording disk manufacturing system of an embodiment of the invention is described. FIG. 4 is a schematic view of a magnetic recording disk manufacturing system of an embodiment of the invention. The system shown in FIG. 4 is composed mainly of, a texture formation apparatus 2 that forms the texture 17 on the glass-made substrate 11, a cleaning apparatus 3 that cleans the substrate 11 after the texture 17 is formed, a substrate-coat deposition apparatus 4 that deposits the substrate overcoat 13 after the cleaning in the cleaning apparatus 3, a main film-deposition apparatus 5 where the underlying film 14, the magnetic film 12 and the overcoat 15 are continuously deposited in this order on the substrate coat 13, a lubricant-film coating apparatus 6 that coats the lubricant film 16 on the overcoat 15.

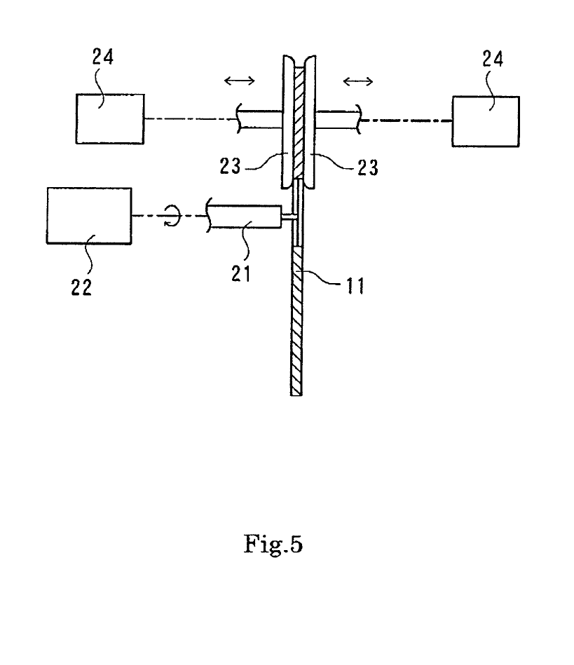

The texture formation apparatus 2 is described first. FIG. 5 is a schematic view of the texture formation apparatus 2 shown in FIG. 4. As shown in FIG. 5, the texture formation apparatus 2 is composed mainly of a holder 21 that holds the substrate 11, a rotation mechanism 22 that rotates the substrate 11 through the holder 21, a contact board 23 that contacts the substrate 11, a pressure-coordination mechanism 24 that coordinates pressure of the contact board 23 onto the substrate 11.

The holder 21 holds the substrate 11 at the edge of the opening. The rotation mechanism 22 rotates the substrate 11 around a rotation axis coaxial with the substrate 11 by rotating a holding rod composing the holder 21. Many minute protrusions are provided on the surface of the contact board 23. The minute protrusions are formed by fixing diamond grains of about 0.1-0.2 μm in diameter on the contact board 23. The diamond grains are fixed, for example, by a sintering method. Concretely, slurry in which the diamond grains are dispersed uniformly is coated on a board. The diamond grains are fixed with the board by sintering the slurry. A fore-and-back movement mechanism comprising a torque motor can be used as the pressure-coordination mechanism 24. The contact pressure of the contact board 23 onto the substrate 11 is coordinated by controlling the output torque of the torque motor. The contact board 23 is prevented from rotating together with the substrate 11 while it is in contact on the substrate 11.

In state that the substrate 11 is held by the holder 21, the contact board 23 contacts the substrate 11. Coordinating the contact pressure by the pressure-coordination mechanism 24, the substrate 11 is rotated by the rotation mechanism 22. As a result, the surface of the substrate 11 is grinded by the protrusions on the contact board 23, thereby forming the described texture 17 on the substrate 11. The contact board 23 and the pressure-coordination mechanism 24 are provided at both sides of the substrate 11 so that the texture 17 can be formed on both surfaces of the substrate 11. Instead of the described composition, it is possible to employ the composition where the texture 17 is formed by rotating the substrate 11 in state that slurry in which diamond grains are dispersed uniformly is sandwiched by a pressing board and the substrate 11.

The cleaning apparatus 3 is to remove contaminant or refuse adhering to the substrate 11. When the substrate 11 is grinded for the texture formation, fragments of small pieces are produced. Such the fragments may adhere to the substrate 11. If the substrate coat 13 or another film is deposited in state that such the fragments remain on the substrate 11, there arise problems that; adhesion intensity of a film decreases, minute protrusions are formed on a film causing deformation defect, or magnetic characteristics of the magnetic film 12 is deteriorated. Therefore, the substrate 11 is cleaned by the cleaning apparatus 3.

The cleaning apparatus 3 is composed of a cleaning bath in which cleaning liquid such as pure water is stored, a dryer for drying the substrate 11 after the cleaning, and other components. A multiplicity of the substrates 11 are contained in a container (not shown) and dipped into the cleaning liquid, thereby cleaning the substrate 11. A means for heating the cleaning liquid or applying supersonic vibration to the substrate 11 is added if necessary.

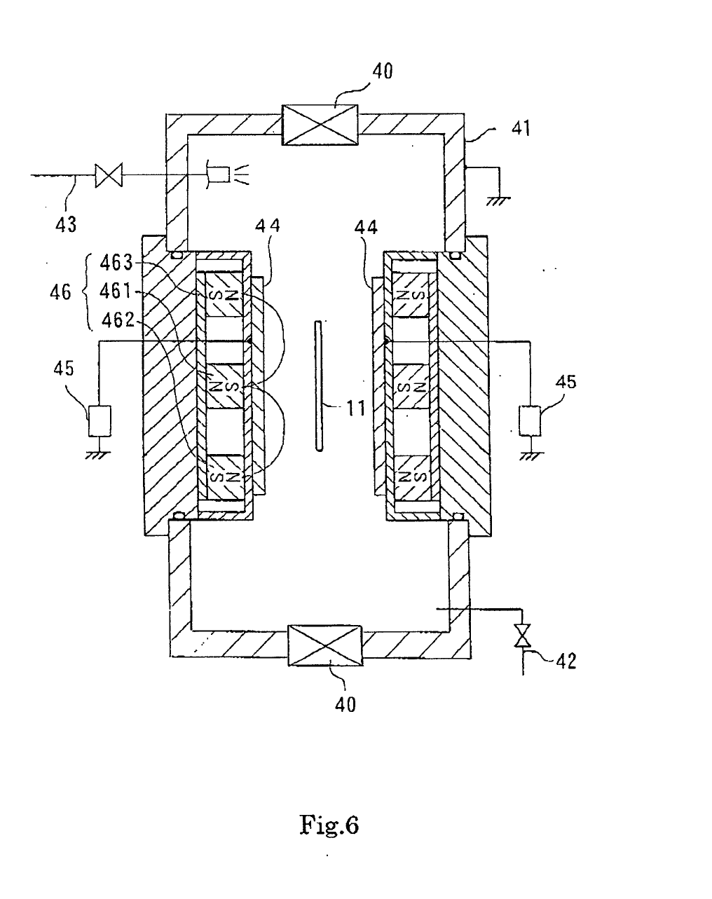

The substrate-coat deposition apparatus 4 is described using FIG. 6. FIG. 6 is a plane view of the substrate-coat deposition apparatus 4 shown in FIG. 4. The substrate-coat deposition apparatus 4 is composed of, a substrate-coat deposition chamber 41 that is a vacuum chamber, a pumping line 42 through which the substrate-coat deposition chamber 41 is pumped, a gas introduction line 43 through which a gas for the sputtering is introduced into the substrate-coat deposition chamber 41, a target 44 which surface to be sputtered is exposed to the inside of the substrate-coat deposition chamber 41, a sputtering power supply 45 that applies voltage for the sputtering to the target 44, a magnet unit 46 provided behind the target 44 for enabling the magnetron sputtering, and other components.

A load-lock chamber (not shown) and a pre-heat chamber (not shown) are connected with the substrate-coat deposition chamber 41 interposing the gate valve 40. The pre-heat chamber is to heat the substrate 11 up to a specific temperature prior to thin-film depositions. The pre-heat chamber comprises a heater such as a radiation lamp heater to heat the substrate 11.

A gas of high sputtering yield such as argon is introduced through the gas introduction line 43 at a specific flow rate. A vacuum pump (not shown) is provided on the pumping line 42. The target 44 is made of the same material as the substrate coat 13. The target 44 is made of NiP in case a NiP film is deposited, or of NiB in case a NiB film is deposited.

The magnet unit 46 is composed mainly of a center magnet 461, an outer magnet 45 surrounding the center magnet 461, and a yoke 463 interconnecting the center magnet 461 and the outer magnet 462. Magnetic lines applied between the center magnet 461 and the outer magnet 462 penetrate through the target 44. Closed space is formed by the surface of the target 44 and the magnetic lines. Because electrons are confined in the closed space, a highly efficient sputtering discharge is established, thereby enabling the high-speed sputtering. The target 44, the sputtering power supply 45 and the magnet unit 46 are provided at both sides of the substrate 11. This is to deposit the substrate coat 13 on both surfaces of the substrate 11.

A carrier holding the substrate 11 is used for transferring the substrate 11 between the substrate-coat deposition chamber 41 and the outside atmosphere. Compositions disclosed in the Japanese laid-open No H11-91945 and the Japanese laid-open No. H11-91946 can be employed for this carrier. For composition to transfer the carrier holding the substrate 11, composition disclosed in the Japanese laid-open No. H8-274142 can be employed.

In FIG. 6, the carrier on which the substrate 11 is mounted is transferred from the outside atmosphere to the pre-heat chamber via the load-lock chamber. After heating the substrate 11 up to 100-150° C. in the pre-heat chamber, the substrate 11 is carried to the substrate-coat deposition chamber 41 through the gate valve 40. After closing the gate valve 40, the gas is introduced through the gas introduction line 43. Pressure in the substrate-coat deposition chamber 41 is maintained at a specific vacuum pressure by pumping through the pumping line 42. In this state, operation of the sputtering power supply 45 is started to apply negative direct voltage or high-frequency (HF) voltage to the target 44, thereby igniting the sputtering discharge. Through the sputtering discharge, particles released from the target 44 arrive at the substrate 11. The particles accumulate on the substrate, growing to be the substrate coat 13.

The main film-deposition apparatus 5 has the composition where the underlying film 14 and the magnetic film 12 by the sputtering, and the overcoat 15 is deposited by the CVD. The main film-deposition apparatus 5 is the inline-type apparatus where a load-lock chamber, the underling-film deposition chamber, a magnetic-film deposition chamber, and an overcoat deposition chamber are connected in this order interposing gate valves. For such the composition, disclosure in the Japanese laid-open No. H11-229150 can be employed. The overcoat deposition chamber may be modified to one where the overcoat 15 is deposited by the sputtering.

Composition where the lubricant film 16 is coated by the vacuum evaporation is employed for the lubricant-film coating apparatus 6. Concretely, the lubricant-film coating apparatus 6 is composed mainly of a vacuum chamber comprising a pumping line, a pot provided in the vacuum chamber, lubricant stored in the pot, a heater for heating the lubricant in the pot.

Whole operation of the magnetic recording disk manufacturing system is described as follows. The following is also the description about an embodiment of the magnetic recording disk manufacturing method of the invention.

First, the texture 17 is formed on both surface of the glass-made substrate 11. Then, the substrate 11 is cleaned in the cleaning apparatus 3, and dried. Next, the substrate coat 13 is deposited on the substrate 11 in the substrate-coat deposition apparatus 4. Afterward, the underlying film 14, the magnetic film 12, and the overcoat 15 are deposited continuously in the main film-deposition apparatus 5. By coating the lubricant film 16 on the overcoat 15, the series of manufacturing process is completed.

The described embodiments present a highly reliable magnetic recording disk, which is transformed very a little even under high-speed rotation in writing and reading out data. Additionally, because the texture 17 is formed directly on the glass-made substrate 11, the embodiments are free from problems arising in case that the texture is formed by grinding a metal-made film. Concretely, the embodiments do not have the problem that the configuration of the texture is made out of uniform to bring deterioration of the magnetic characteristics. The embodiments neither have the problem that collision of a magnetic head to a disk frequently happens. Because the substrate coat 13 is deposited by the sputtering, the configuration of the texture 17 is preserved sufficiently. Therefore, much improvement of the magnetic recording reliability by the magnetic anisotropy is expected.

Though the hard disk is adopted as an example of magnetic recording disks, this invention can be applied to another disk such as a flexible disk and a ZIP disk. Magnetic recording disk of this invention includes a disk utilizing function other than magnetism in addition to function of magnetism, such as a magneto-optical recording disk.

What is claimed is:

1. A magnetic recording disk, comprising a disk-shaped substrate and a magnetic film provided on said substrate for magnetic recording, wherein;
said substrate is made of glass,
a texture for giving magnetic anisotropy with said magnetic film is formed with a surface of said substrate,
a substrate coat is deposited over said texture, and
said magnetic film is provided on said substrate coat.

2. A magnetic recording disk as claimed in claim 1, wherein;
said substrate coat is made of nickel phosphide or nickel boride, and is deposited by sputtering.

3. A method for manufacturing a magnetic recording having structure where a magnetic film for magnetic recording is deposited on a disk-shaped substrate, comprising;
a step to form a texture with a surface of said substrate, said texture being for giving magnetic anisotropy with said magnetic film,
a step to deposit a substrate coat over said texture, and
a step to deposit said magnetic film on said substrate coat.

4. A method for manufacturing a magnetic recording disk as claimed in claim 3, wherein;
said substrate coat is made of nickel phosphide or nickel boxide, and is deposited by sputtering.

5. A system for manufacturing a magnetic recording having structure where a magnetic film for magnetic recording is deposited on a disk-shaped substrate, comprising;
a texture formation apparatus that forms a texture with a surface of said substrate, said texture being for giving magnetic anisotropy with said magnetic film,
a substrate-coat deposition apparatus that deposits a substrate coat over said texture, and
a main film-deposition apparatus that deposits films including said magnetic film on said substrate coat.

6. A system for manufacturing a magnetic recording disk as claimed in claim 5, wherein;
said substrate-coat deposition apparatus deposits said substrate coat made of nickel phosphide or nickel boride by sputtering.
